(19) United States
(12) Patent Application Publication
(10) Pub. No.: US 2007/0089158 A1
(43) Pub. Date: Apr. 19, 2007

(54) APPARATUS AND METHOD FOR PROVIDING ACCESS TO ASSOCIATED DATA RELATED TO PRIMARY MEDIA DATA

(76) Inventor: Christopher M. Clark, Knoxville, TN (US)

Correspondence Address: LUEDEKA, NEELY & GRAHAM, P.C., P O BOX 1871, KNOXVILLE, TN, 37901, US

(21) Appl. No.: 11/559,922

(22) Filed: Nov. 15, 2006

Related U.S. Application Data
(63) Continuation-in-part of application No. 11/253,195, filed on Oct. 18, 2005.
(63) Continuation-in-part of application No. 11/328,948, filed on Jan. 10, 2006.
(63) Continuation-in-part of application No. 11/422,735, filed on Jun. 7, 2006.

(51) Int. Cl. H04N 7/16; H04N 7/173; H04N 7/18

(52) U.S. Cl. 725/135; 725/136; 725/81; 725/112

(57) ABSTRACT

Apparatuses and methods are described for distributing associated data to media recipients that are experiencing a primary media event, such as a television or radio program, a movie or a live event. The associated data may be in the form of direct links that may be used by the media recipients to access supplemental information, such as a website accessible via the Internet, that is in some way associated with or related to the primary media event. Since the associated data leads the media recipients directly to the supplemental information, the media recipients do not need to search for the supplemental information on their own. In various embodiments, a direct link is transmitted wirelessly to a wireless communication device that uses the link to access the supplemental information. In some situations, the direct link is extracted or copied from the primary media data stream. Thus, associated data may be extracted from a one-way primary media data stream and used to interactively access supplemental information from a two-way information medium, such as the Internet or wireless communication networks.

This application claims priority as a continuation-in-part to U.S. patent application Ser. Nos. 11/253,195 filed Oct. 18, 2005, titled TELEVISION INTERFACE SYSTEM, 11/328,948 filed Jan. 10, 2006, titled TELEVISION ADVERTISING NUMBER SYSTEM, and 11/422,735 filed Jun. 7, 2006, titled MEDIA CONTROL SYSTEM.

### FIELD

This invention relates to the field of media data transfer and presentation. More particularly, this invention relates to a system for providing access to associated data that is related to primary media data.

### BACKGROUND

Media outlets are continuously seeking new and unique ways to provide information to media consumers. In particular, media outlets are always seeking innovative ways to provide an advertiser's message to a potential consumer in a way that attracts the consumer's attention and prompts the consumer to seek further information about an advertised product or service. The current challenge is to present advertising information without relying completely upon traditional methods, such as annoying strings of commercials sandwiched between segments of a television or radio program.

One approach has been “product placement” in movies and television shows, wherein an advertiser's product is featured prominently within a scene in a movie or television program. Although this approach has been effective in getting consumers to notice the advertiser's product, the amount of product information that can be conveyed in this manner is limited. It would be desirable to provide the consumer an easy and enjoyable way to access further information about the advertised product or service, such as by accessing information on a website or receiving information via email.

What is needed is a way to direct a consumer to additional information regarding a product or service while the consumer is experiencing a media program or event, so that the consumer can seek out the additional information, either during the program or event, or thereafter.

### SUMMARY

To meet the above and other needs, various embodiments of the invention provide apparatuses and methods for distributing associated data to media recipients that are experiencing a primary media event, such as a television or radio program, a movie or a live event. The associated data may comprise direct links used by the media recipients to access supplemental information, such as a website accessible via the Internet, that is in some way associated with or related to the primary media event. Because the direct links lead the media recipients directly to the supplemental information, the media recipients do not need to search for the supplemental information on their own.

In various embodiments of the invention, a direct link is transmitted to a communication device that uses the link to access the supplemental information. In some situations, the direct link is extracted or copied from a data stream that carries the primary media data to the media recipient. Thus, embodiments of the invention extract associated data from a “one-way” primary media data stream and use the associated data to interactively access supplemental information from a “two-way” information medium, such as the Internet or wireless communication networks. In this way, the invention provides a way for one-way media, such as television, radio, movies and videos, to patch into the two-way media, such as the Internet and wireless communication networks.

The presentation of the primary media data can be thought of as a “lean back” sort of experience which is not substantially interactive. However, use of the direct links provide a “lean forward” or interactive experience which enhances the primary media event as the media recipient uses the links to access the supplemental information.

In a preferred embodiment, the invention provides a method for transferring media information from a media data source to a media recipient. The method includes (a) receiving a media data stream from the media data source, where the media data stream contains primary data and associated data. The primary data comprises a primary media presentation and the associated data points to supplemental information that is related to the primary media presentation. The method also includes (b) presenting the primary media presentation to the media recipient based on the primary data, (c) accessing the associated data in the media data stream, (d) determining based on the associated data a location of the supplemental information, (e) accessing the supplemental information at the location determined in step (d), and (f) presenting the supplemental information to the media recipient.

In some preferred embodiments, step (a) comprises receiving the media data stream from a television programming service provider and step (b) comprises presenting television programming on a television display device. In some embodiments, step (a) comprises receiving the media data stream from a radio programming service provider and step (b) comprises presenting radio programming using an audio device. In other embodiments, step (a) comprises receiving the media data stream from a digital media player device such as a DVD player, a CD player or a digital music player. In yet other embodiments, step (a) comprises receiving the media data stream from a cinematic movie presentation device and step (b) comprises presenting a cinematic feature in a movie theater using a projection device. In some embodiments, step (a) comprises receiving the media data stream from a video data source for a large-format video display device used at a live event and step (b) comprises presenting video programming on the large-format video display device at the live event.

In another aspect, the invention provides an apparatus for operating on a media data stream that contains primary data and associated data, where the primary data comprises a primary media presentation and the associated data points to supplemental information that is related to the primary media presentation. In preferred embodiments, the apparatus includes an associated data access device and an associated data receiving device. The associated data access device comprises a media data stream input for receiving the media data stream from a media data source, an extraction circuit for accessing the associated data in the media data stream, an associated data output for providing the associated data to the associated data receiving apparatus, and a primary data output for providing the primary data to a primary data presentation device. The associated data receiving apparatus is for receiving the associated data, accessing the supplemental information at a location indicated by the associated data, and presenting the supplemental information to a media recipient.

In some embodiments, the associated data receiving device is a cellular phone, a personal digital assistant device having wireless communication capability or a laptop computer having wireless communication capability. In other embodiments, the associated data receiving device is a component of a personal computer or laptop computer, and the supplemental information is provided to a display device associated with the personal computer or laptop computer.

In some embodiments, the associated data access device is a component of a cellular phone, a digital media player, a digital music player, a DVD player, CD player, a personal digital assistant device, a laptop computer, a personal computer, a satellite television receiver unit, a cable television receiver unit, a terrestrial television receiver unit, a satellite radio receiver unit or a terrestrial radio receiver unit.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a functional block diagram of an apparatus for providing access to associated data related to primary media data according to a preferred embodiment of the invention;

FIG. 2 depicts a flow diagram of a method for providing access to associated data related to primary media data according to a preferred embodiment of the invention;

FIG. 3 depicts a flow diagram of a method for providing access to associated data related to primary video data according to a preferred embodiment of the invention;

FIG. 4 depicts a flow diagram of a method for providing access to associated data related to primary video data according to an alternative embodiment of the invention;

FIG. 5A depicts a functional block diagram of an apparatus for providing access to associated data related to primary media data according to a preferred embodiment of the invention;

FIG. 5B depicts a functional block diagram of an apparatus for providing access to associated data related to primary media data according to an alternative embodiment of the invention;

FIG. 6 depicts a functional block diagram of an apparatus for providing access to associated data related to primary video data according to a first embodiment of the invention;

FIG. 7 depicts a functional block diagram providing further details of the apparatus of FIG. 6;

FIG. 8 depicts an example of associated data embedded in a primary media data stream;

FIG. 9 depicts a functional block diagram providing further details of the apparatus of FIG. 6;

FIG. 10A depicts an example of a primary video media presentation which includes a link to supplemental information according to a preferred embodiment of the invention;

FIG. 10B depicts an example of supplemental information in the form of a webpage displayed on a display device according to a preferred embodiment of the invention;

FIG. 11 depicts a functional block diagram of an apparatus for providing access to associated data related to primary media data according to a second embodiment of the invention;

FIG. 12 depicts a flow diagram of a method for providing access to associated data related to primary media data according to another embodiment of the invention;

FIG. 13 depicts a functional block diagram of an apparatus for providing access to associated data related to primary media data according to a third embodiment of the invention;

FIG. 14 depicts a functional block diagram of an apparatus for providing access to associated data related to primary media data according to a fourth embodiment of the invention; and

FIG. 15 depicts a flow diagram of a method for providing access to associated data related to primary media data according to yet another preferred embodiment of the invention.

### DETAILED DESCRIPTION

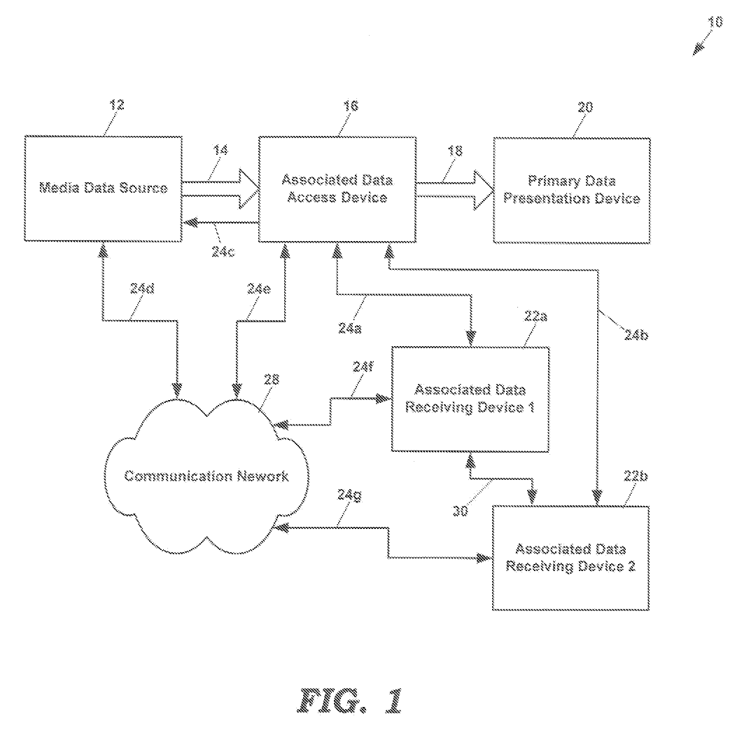

FIG. 1 depicts a preferred embodiment of a system 10 for providing access to associated data that is related to primary media data. For the purpose of this description, “primary media data” is information that provides or conveys media content. For example, primary media data includes but is not limited to video data, audio data, graphics data and/or textual data conveyed by any means. For the purpose of this description, “associated data” is information in any form that leads to or points to a source of additional information that is in some way related to the primary media data. For example, associated data may include but is not limited to a link to a webpage, a network address, a computer application, a computer file, an email message, a text message, a voice message or a data string.

Video data includes television data such as may be conveyed by satellite, cable or wireless terrestrial signals, video information stored on a storage medium such as a digital versatile disk (DVD) or other optical disk or magnetic hard drive, video information conveyed via a communication network such as the Internet, video information displayed on a large-format video display screen such as a Sony JumboTron™ screen, and video information projected in a movie theater. Video data may be encoded in any one of a number of formats, such as MPEG-4, Sorenson 3, Theora and Windows Media Video.

Audio data includes radio data such as may be conveyed by satellite, cable or wireless terrestrial signals, audio information stored on a storage medium such as compact disk (CD) or other optical disk or magnetic hard drive, audio information presented at a live media event such as a concert or sporting event, audio information in a cinematic movie soundtrack, and audio information conveyed via a communication network such as the Internet. Audio data may be encoded in any one of a number of formats, such as MP3, Dolby Digital, DTS and Windows Media Audio.

As shown in FIG. 1, the system 10 includes a media data source 12 which provides or conveys the primary media data. In preferred embodiments, the media data source 12 is a satellite television service provider cable television service provider, terrestrial television broadcaster, satellite radio service provider, cable radio service provider, terrestrial radio broadcaster, the Internet, a digital media player of a personal computer, a DVD player, CD player, MP3 player, digital tape player, a computer hard drive, an optical disk drive or cinematic movie soundtrack. It should be appreciated that the media data source 12 of the present invention is not limited to the above-listed devices or sources. The media data source 12 generates or conveys a media data stream which is represented by the arrow 14. In preferred embodiments, the media data stream 14 carries the primary media data and the associated data together. In alternative embodiments, some or all of the associated data is conveyed via a channel or path which is separate from the media data stream 14.

With continued reference to FIG. 1, the system 10 includes an associated data access device 16 which receives the media data stream 14 provided by the media data source 12. In preferred embodiments of the invention, the associated data access device 16 accesses the associated data which is present in the media data stream 14 or in an associated channel. As described in more detail below in connection with certain embodiments, the associated data access device 16 detects the presence of associated data, extracts or copies the associated data from the media data stream 14 or other channel, decodes the associated data (if necessary) and writes the associated data to memory in the associated data access device 16. In various embodiments, the associated data access device 16 is a component of a satellite television receiver, terrestrial television receiver or cable television receiver (any of which may also be referred to herein as a “set top box” (STB)), a component of a television receiver card of a personal computer, a component of a digital video recorder, a component of a satellite radio receiver, terrestrial radio receiver or cable radio receiver, a component of a wireless mobile communication device, such as a cellular phone or PDA, or a component of a DVD player, CD player or other digital media player.

In preferred embodiments of the invention, the associated data access device 16 decodes and processes the primary media data in the media data stream 14 to generate a media information signal 18. The media information signal 18 carries the primary media program in the form of video and/or audio information content to a primary data presentation device 20 which presents the primary media program to a media recipient. In alternative embodiments, the associated data access device 16 passes the primary media data through unaltered after accessing the associated data. In these embodiments, the primary data presentation device 20 decodes and processes the primary media data.

The associated data access device 16 provides the associated data via a data link 24a to an associated data receiving device 22a. Some embodiments of the invention include more than one associated data receiving device and data link thereto, such as the additional device 22b and data link 24b depicted in FIG. 1. In preferred embodiments of the invention, the associated data receiving devices 22a and 22b each comprise a personal computer, a laptop computer, a server computer, a personal digital assistant (PDA), a cellular phone or other wireless communication device, or a component of any of these devices. Generally, functions of the associated data receiving devices 22a and 22b include receiving the associated data from the associated data access device 16, accessing supplemental information at one or more locations indicated by the associated data and presenting the supplemental information to a media recipient.

For purposes of this description, “supplemental information” is information in any form to which the associated data points or leads that is in some way related to the primary media data. For example, supplemental information may include but is not limited to a webpage, a computer application, an email message, a video data file, an audio data file, a text data file, a text message, a voice message or an image data file. Various examples of supplemental information are described in more detail below.

In the embodiment of FIG. 1, the media data source 12, the associated data access device 16 and the associated data receiving devices 22a and 22b are in communication with a wide area communication network 28, such as the Internet.

In some embodiments, the associated data access device 16 can communicate with the associated data receiving device 22a via an indirect communication link that consists of (1) a network connection 24c between the associated data access device 16 and the media data source 12, (2) a network connection 24d between the media data source 12 and the communication network 28 and (3) a network connection 24f between the communication network 28 and the associated data receiving device 22a. In a preferred embodiment, the network connection 24c is provided on the same communication conduit as the primary media data 14. For example, if the media data source 12 is a cable television provider, the connection 24c and the cable television data 14 may be provided via the same physical coaxial cable or optical fiber.

In some embodiments, the associated data access device 16 can additionally or alternatively communicate with the associated data receiving device 22a via an indirect communication link that consists of (1) a network connection 24e between the associated data access device 16 and the communication network 28 and (2) the network connection 24f between the communication network 28 and the associated data receiving device 22a.

Similarly, various alternative connection options exist between the associated data access device 16 and the associated data receiving device 22b which incorporate the network connection 24g.

In some preferred embodiments of the invention, the links 24a-24g are wireless data links, such as WiFi links (IEEE 802.11), Bluetooth links (IEEE 802.15.1), cellular links (such as Global System for Mobile communications (GSM)) or an infrared serial links. In other preferred embodiments, the links 24a-24g are wired links, such as via a Universal Serial Bus (USB), a Peripheral Component Interconnect (PCI) bus, a local area network (LAN), or a wide area network (WAN) such as the Internet.

In some preferred embodiments, the associated data receiving device 22a simply stores the associated data in memory and passes it along to another associated data receiving device 22b via a direct data link 30 or via the communication links 24f and 24g and the communication network 28. The second associated data receiving device 22b may perform any or all of the functions of the first associated data receiving device 22a described above, and in preferred embodiments it comprises a personal computer, a laptop computer, a server computer, a personal digital assistant (PDA), a cellular phone or other wireless communication device, or a component of any of these devices. The direct data link 30 may be a wireless data link, such as a WiFi link, a Bluetooth link, a cellular link or an infrared serial link. Alternatively, the direct link 30 may be a wired connection, such as via a USB link, a PCI bus, a LAN link or a WAN link.

As shown in FIG. 1, the primary data presentation device 20 receives the primary media information 18 from the associated data access device 16. In preferred embodiments wherein the associated data access device 16 decodes and processes the primary media data, the primary data presentation device 20 comprises a television display device, an audio receiver/amplifier and speaker system, an LCD screen of a computer, PDA or cellular phone, a cinematic movie projector, a digital projector or a large-format video display device. In embodiments wherein the associated data access device 16 passes through the primary media data, the primary data presentation device 20 includes the decoding and processing components needed to provide the primary media information in a format which is compatible as input to a television display device, an audio receiver/amplifier and speaker system, an LCD display screen, a cinematic movie projector, a digital projector or a large-format video display device.

In some embodiments of the invention, the associated data access device 16, the associated data receiving device 22a, and the primary data presentation device 20 are components of a single media presentation device, such as a personal computer, a laptop computer, PDA or cellular phone. Such embodiments are described in more detail below.

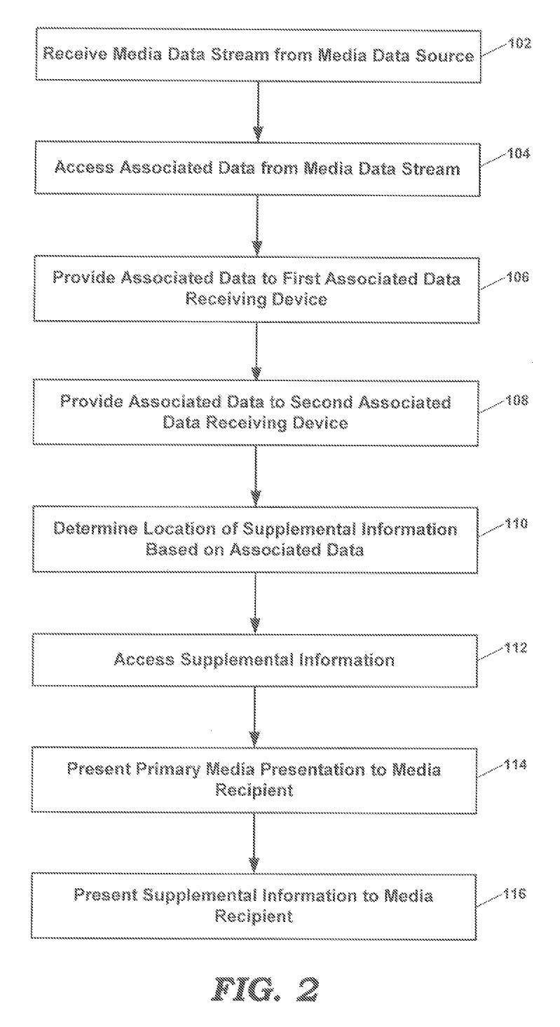

FIG. 2 depicts a method for transferring media information from a media data source to a media recipient using the embodiment of the invention depicted in FIG. 1. This method includes receiving a media data stream 14 containing television, movie, radio, music or live event data from the media data source 12 (step 102). Associated data within the media data stream 14 is accessed using an associated data access device 16 (step 104), and the associated data is provided to a first associated data receiving device 22a (step 106). In some embodiments of the invention, the associated data may also be provided to a second associated data receiving device 22b (step 108), such as by transferring the associated data from the first associated data access device 22a via the data link 30. Based on the associated data, a location, such as a network address, of supplemental information is determined (step 110). The supplemental information is then accessed, such as by the first associated data receiving device 22a or the second associated data receiving device 22b (step 112), and the supplemental information is presented to the media recipient (step 116.) At some point during the process, the primary media content, such as the television, movie, radio, music or live event content, is also presented to the media recipient via the primary data presentation device 20 (step 114).

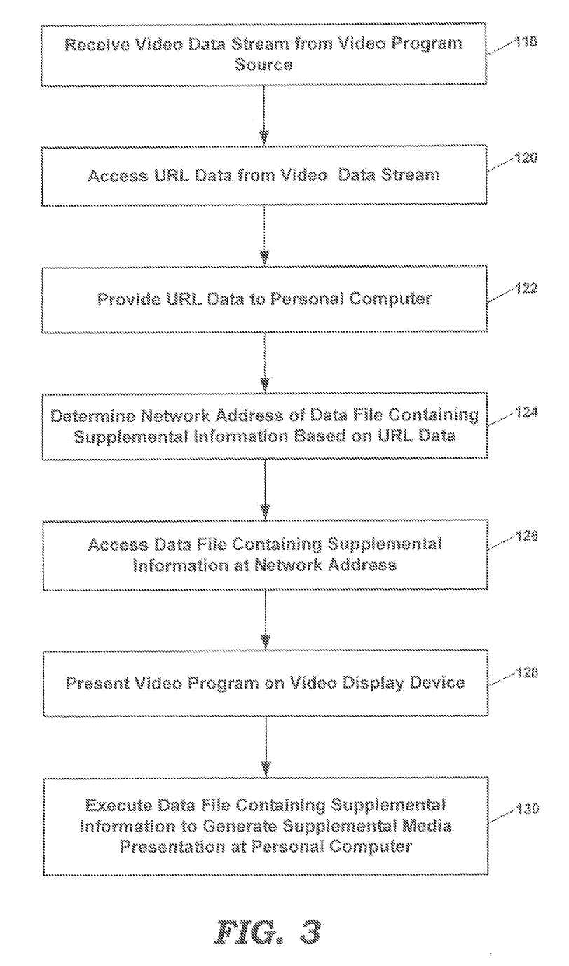

One embodiment of the method of FIG. 2 is depicted in FIG. 3. In this embodiment, the method includes receiving a video data stream 14, such as an MPEG-2 or MPEG-4 video stream, from a video data source 12, such as a satellite or cable television provider, a DVD player, a digital tape player or a computer media player (step 118). A Uniform Resource Locator (URL) embedded in the video data stream 14 is accessed using the associated data access device 16 (step 102) and the URL is provided to a personal computer 22a (step 122). Based on the URL, a network address of a supplemental information data file is determined (step 124). The supplemental information data file, such as a Hypertext Markup Language (HTML) file, video file or audio file, is then accessed at the indicated address (step 126) and is provided to the personal computer 22a where the supplemental information is presented to the media recipient (step 130). At some point during the process, the primary media content, such as the television program, movie or other video program, is also presented to the media recipient using a video display device 20 (step 128).

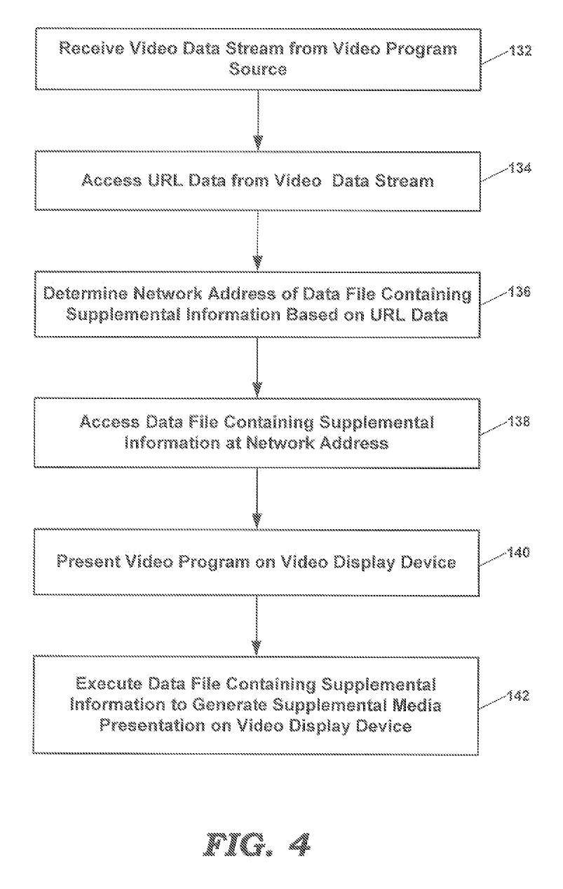

Another embodiment of the method of FIG. 2 is depicted in FIG. 4. In this embodiment, the method includes receiving a video data stream 14, such as an MPEG-2 or MPEG-4 video stream, from a video data source 12, such as a satellite or cable television provider, a DVD player or a computer media player (step 132). As in the embodiment of FIG. 3, a URL embedded in the video data stream 14 is accessed using the associated data access device 16 (step 134). However, in the embodiment of FIG. 4, the URL is not provided to a personal computer. Rather, the URL is processed by the associated data access device 16 to determine a network address of a supplemental information data file (step 136). The supplemental information data file, such as an HTML file or video file, is then accessed at the indicated address (step 138) and is presented to the media recipient on the video display device 20 (step 142). At some point during the process, the primary video content is also presented to the media recipient on the same video display device 20 (step 140).

The method of FIG. 4 encompasses an embodiment wherein the primary media data, such as a video clip or music clip, is received by a cellular phone or wireless PDA device, circuitry within the phone or PDA accesses a URL encoded in the video or music clip, and the phone or PDA uses the URL to access a webpage related to the video or music clip. The method of FIG. 4 also encompasses an embodiment wherein the primary media data is a media data file played using a media player application on a personal computer, an application running on the computer accesses a URL encoded in the media data file, and the computer uses the URL to access a webpage related to the content of the media data file.

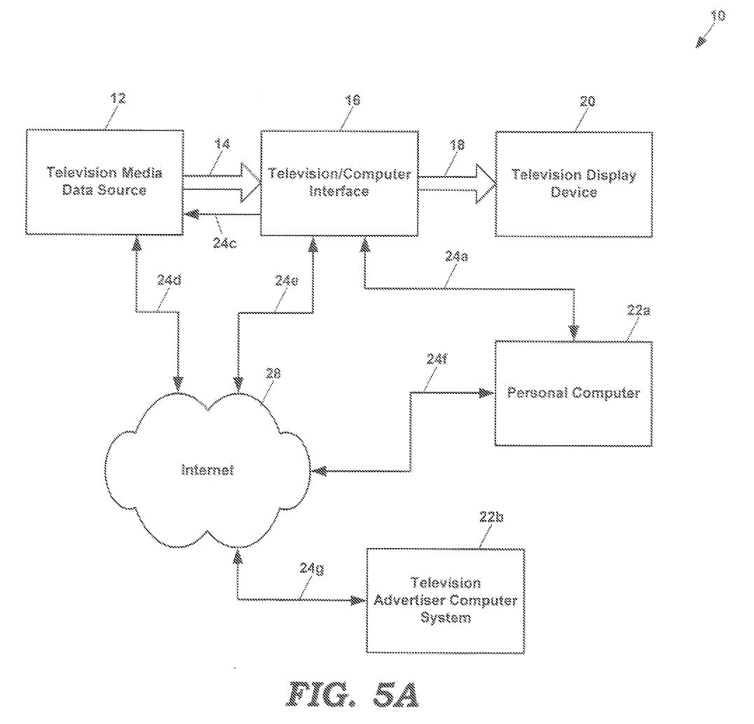

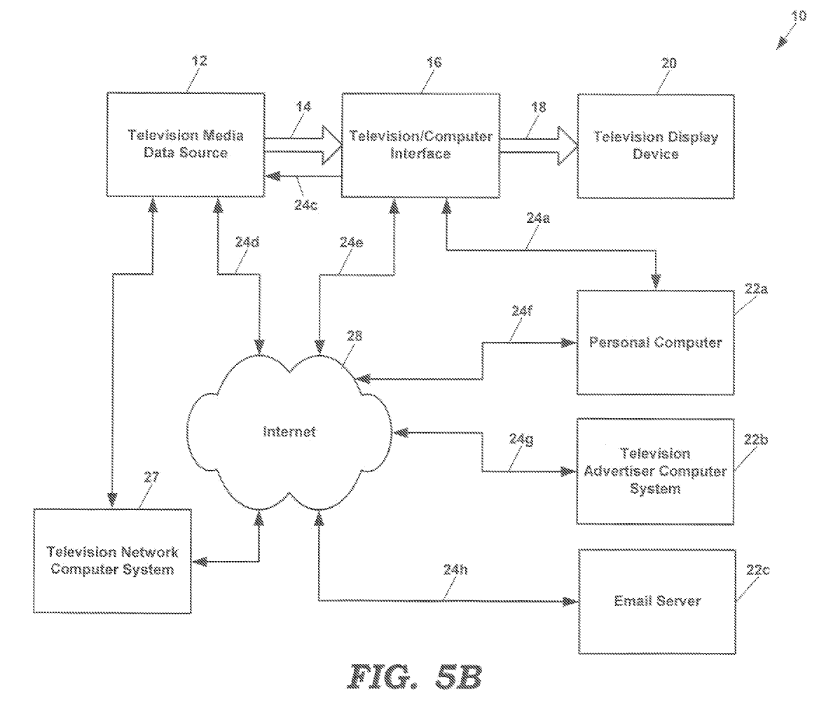

FIG. 5A depicts a preferred embodiment of the invention wherein the primary media content is television programming. In this embodiment, the media data source 12 is a television media data provider 12, such as a cable or satellite television service provider. The associated data access device 16 of this embodiment comprises a television/computer interface 16, the associated data receiving device comprises a personal computer 22a, and the primary data presentation device comprises a television display device 20.

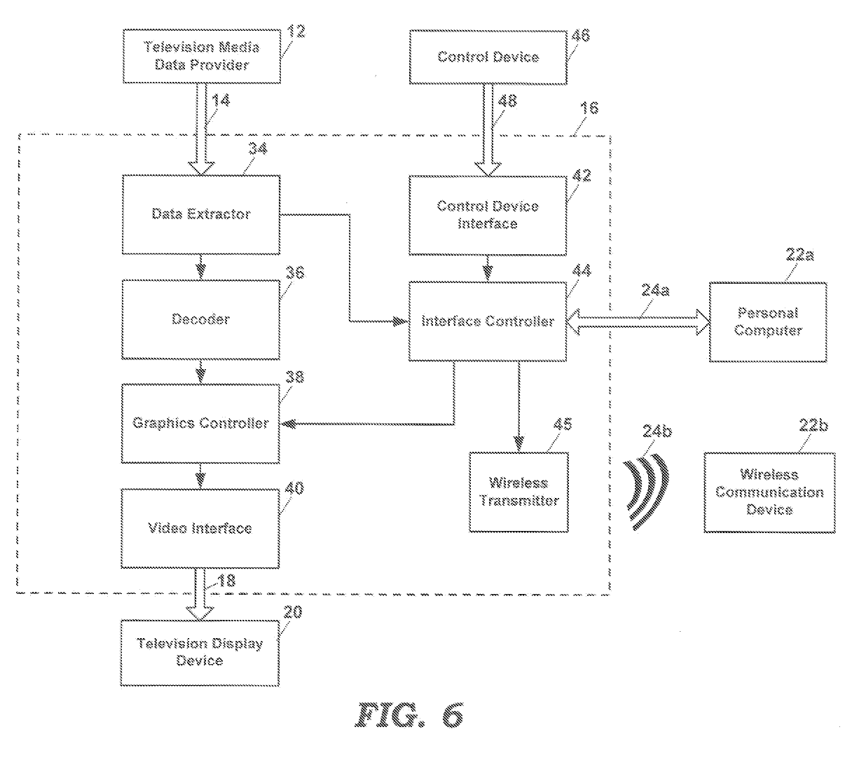

FIG. 6 depicts components of the television/computer interface 16 which may be contained in a set-top box according to a preferred embodiment of the invention. The television/computer interface 16 includes a data extractor 34 that receives the digital media stream 14 from the television media data source 12. The purpose of the data extractor 34 of this embodiment is to extract or copy the associated data from the media data stream 14 and provide it to the computer 22a.

Associated data may be present in the digital media stream 14 for various purposes, such as to identify the source of the primary television program or the particular type of software that was used to produce or encode the video data. As alluded to previously, associated data may also be used to provide information to consumers regarding products or services depicted in the primary television program.

The associated data may be embedded in a “user data” section of the digital media stream 14. As described in more detail below, the data extractor 34 monitors the encoded digital media stream 14 and “listens” for the beginning of a user data section. When a user data section is detected, the data extractor 34 copies the associated data from the encoded data stream 14 and passes it to an interface controller 44. The interface controller 44 sends the copied data from the data extractor 34 to the computer 22a over the link 24a. In some embodiments, the interface controller 44 extracts graphical data from the associated data and sends it to the graphics controller 38. Although the associated data is copied from the digital media stream 14 as it passes through the data extractor 34, the digital media stream 14 that enters the television/computer interface 16 preferably passes through the data extractor 34 substantially unaltered.

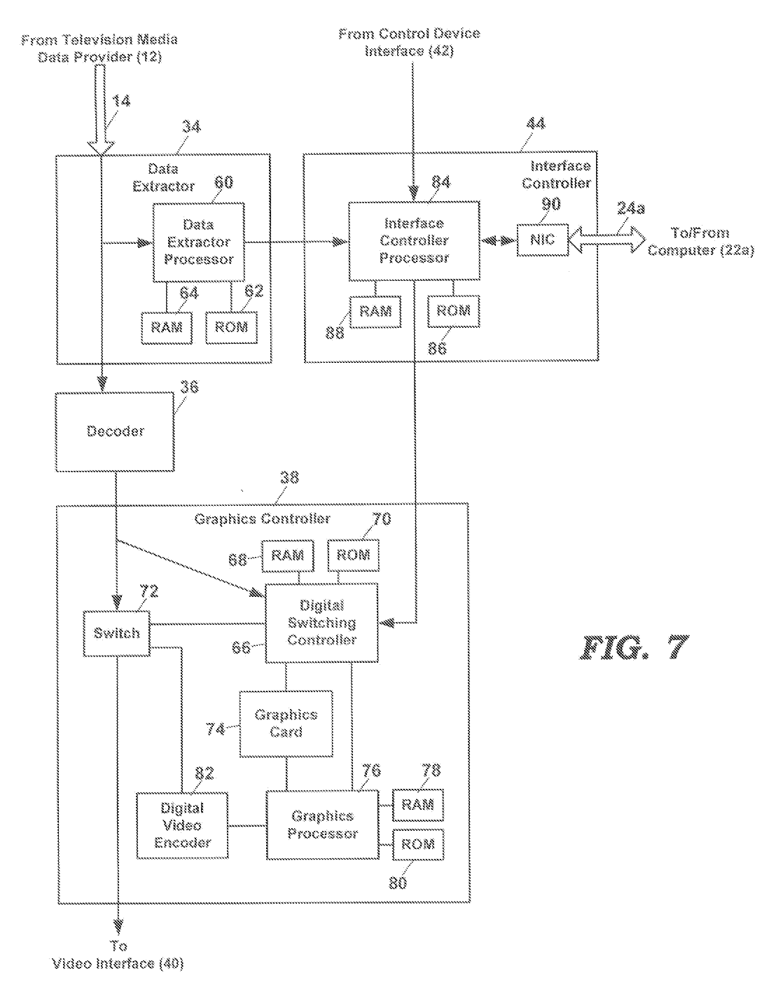

In preferred embodiments of the invention, the data extractor 34 functions as a listening port patched onto the digital media data stream 14. As shown in FIG. 7, the data extractor 34 includes a data extractor processor 60 that monitors the data stream 14 for sequences of the associated data in the digital media signal. The data extractor 34 also includes read-only memory (ROM) 62 for storing programming instructions and random access memory (RAM) 64 for temporary storage of data.

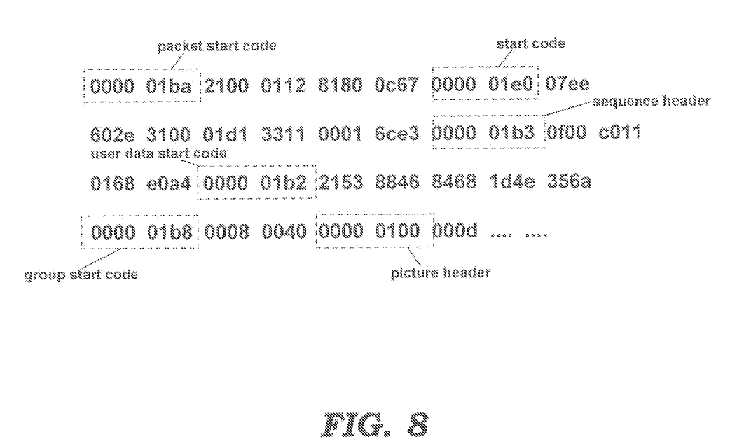

To provide background for describing the operation of the data extractor 34, the data format of an MPEG-2 data stream is first described with reference to FIG. 8, which represents typical MPEG-2 data in hexadecimal format. As shown in FIG. 8, an MPEG-2 data stream may include a number of different “start codes” that indicate the beginning of various portions of the data stream. According to the MPEG-2 standard for digital video as set forth in ISO/IEC 13818-2, start codes are specific bit patterns that do not otherwise occur in the video stream. Each start code consists of a start code prefix followed by a start code value.

According to the MPEG-2 standard, the start code prefix is a string of twenty three bits with the value of zero followed by a single bit with the value one. Thus, the start code prefix is the bit string “0000 0000 0000 0000 0000 0001” (0000 01 in hexadecimal). Immediately following the start code prefix is the start code value. The start code value is an eight bit integer that identifies the type of start code. Most types of start code have just one start code value.

The start code value for the “user data” portion of the MPEG-2 stream is “b2” in hexadecimal. Thus, as shown in FIG. 8, the hexadecimal value for the user data start code is “0000 01b2.” The user data comprises all the data in the data stream that follows the user data start code and precedes a stop code (or the next start code). The user data section can be of any length. In the example of FIG. 8, the user data comprises the string “2153 8846 8468 1d4e 356a.”

The SMPTE Registration Authority, LLC is currently authorized by the International Organization of Standardization (ISO) to register MPEG-2 format identifiers. The registration descriptor of MPEG-2 standard is provided by ISO 13818-1 to enable users of the MPEG-2 standard to unambiguously carry data when the format of the data is not necessarily a recognized international standard. This provision permits the MPEG-2 video transport standard to carry various types of data while providing for a method of unambiguous identification of the characteristics of underlying private data.

Entities that are registered with SMPTE are assigned a unique code that can be recognized in the video stream. Using this registration code, a registered entity can embed specific associated data in the user data section of the video data stream. The registration code can also be used to locate and extract the associated data.

With reference to FIG. 7, the data extractor processor 60 listens for the user data start code (0000 01B2) in the MPEG-2 data stream based on programming instructions stored in the ROM 62. Once the user data start code is detected, the processor 60 jumps to another section of programming in the ROM and begins listening for an appropriate registration code. When the registration code is detected, the processor 60 begins copying all the preceding data into the RAM 64 until a stop code is detected. The processor 60 forwards the data saved in the RAM 64 to the interface controller 44. The processor 60 then recycles and begins listening for the next user data start code.

After the video stream passes through the data extractor 34, a decoder 36, such as an MPEG-2 or MPEG-4 decoder, decodes the digital media stream into a pure digital luminance/chrominance (Y/C) signal. In some embodiments of the invention, the decoded media signal is provided to a graphics controller 38 which combines the media stream data with graphics data from the computer 22a, if it is instructed to do so. Finally, depending again on the application of the television/computer interface 16 and the type of television display device 20 in use, the digital media signal may be converted into one or more analog signals in a video interface 40. Thus, depending on the particular embodiment of the invention, the signal provided to the television display device 20 may be component video, composite video, Digital Visual Interface (DVI), High-Definition Multimedia Interface (HDMI) or other video or multimedia format.

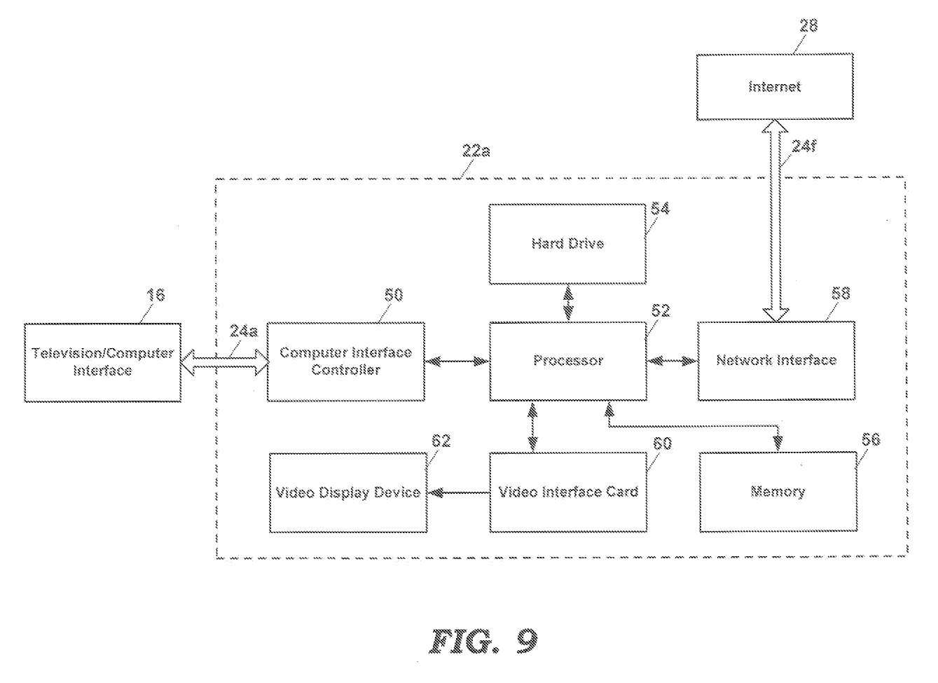

FIG. 9 depicts a preferred embodiment of the computer 22a, which comprises a computer interface controller 50, a processor 52, a hard drive 54, memory 56, a communication network interface 58, a video graphics card 60 and a display device 62. The interface controller 50 may be a local area network interface card, a USB controller or an address/data bus, such as a PCI bus. The interface controller 50 provides the data interface between the television/computer interface 16 and the processor 52.

Using the hard drive 54 and the memory 56, the processor 52 processes the associated data from the television/computer interface 16 depending on the type of associated data received. If the associated data is a link to a webpage accessible via the Internet, the processor 52 uses browser software to fetch the requested webpage via the network interface 58. In a preferred embodiment wherein the webpage graphics are to be displayed on the computer display device 62, the processor 52 generates webpage graphics instructional data based on the link data and provides the graphics instructional data to the computer's video card 60.

As shown in FIG. 7, the interface controller 44 includes an interface controller processor 84 that is in communication with to the control device interface 42, data extractor 34 and graphics controller 38. The control device interface 42 and the data extractor 34 provide data to the processor 84 which operates on the data based on instructions stored in the ROM 86. These instructions determine how the processor 84 is to modify the associated data so that it can be sent to the network interface card (NIC) 90 and on to the computer 22a in a format that can be understood by software running on the computer 22a. After the associated data is modified appropriately, it is stored to the RAM 88 until it is sent to the NIC 90.

In some preferred embodiments, the processor 84 of the interface controller 44 extracts a text string from the associated data and passes the text string to the graphics controller 38 to be inserted into the video displayed on the display device 20. The processor 84 is also responsible for passing the associated data on to the computer 22a via the network interface card 90 and the link 24a. In some embodiments, the interface controller 44 waits for instruction from the control device 46 before it passes the associated data on to the computer 22a. In other embodiments, the interface controller 44 automatically passes the associated data on to the computer 22a whenever the controller 44 receives the associated data from the data extractor 34.

Preferably, these operations work in substantially the same manner in reverse. When the NIC 90 receives data from the network link 24, it sends the data to the processor 84. The processor 84 then uses instructions from the ROM 86 to modify the data appropriately to send it on to the graphics controller 38. The modified data is then stored in the RAM 88 until the proper time to be forwarded to the graphics controller 38.

As shown in FIG. 7, the graphics controller 38 provides a system for generating graphics and embedding them synchronously into the digital media stream. In a preferred embodiment of the invention, the graphics controller 38 includes a digital switching controller 66 with associated RAM 68 and ROM 70, a data switch 72, graphics card 74, graphics processor 76 with associated RAM 78 and ROM 80, and a digital video encoder 82.

In one embodiment, the digital switching controller 66 receives its instructions from the interface controller 44 and divides those instructions into graphics instructions and embedding instructions. The digital switching controller 66 forwards the graphics instructions to the graphics card 74 and saves the embedding instructions in RAM 68. The digital switching controller 66 is also responsible for monitoring the digital media signal that passes through the data extractor 34, preferably in the same manner as the data extractor 34 monitors the digital media signal 14. The digital switching controller 66 monitors the digital media signal for the appropriate location in the data stream to activate the switch 72 to allow graphics to be embedded in the stream. This embedding location is determined based on the embedding instructions that were stored in RAM 68. In a normal mode, the switch 72 allows the digital media signal to pass unaltered. When the switch 72 receives appropriate instructions from the digital switching controller 66, the switch 72 is operated in a graphics insertion mode wherein graphics created in the graphics processor 76 are synchronously inserted into the video stream. In the preferred embodiment, this synchronous switching is accomplished using switching logic gates in the switch 72. An example of a similar switching scheme is that used in cable or satellite set-top boxes to insert programming guide graphics into a video signal along with an incoming video program signal.

In the preferred embodiment, the graphics card 74 operates in the same manner as graphics cards used in personal computers. The graphics card 74 receives the graphics instructions from the digital switching controller 66 in a format which is the same as, or very similar to, the format such instructions would be provided by a personal computer.

Based on the graphics instructions from the digital switching controller 66, the graphics card 74 outputs the graphics data that the graphics processor 76 copied to its RAM 78. The graphics processor 76 then waits for a signal from the digital switching controller 66 that it is time to embed the graphics data into the digital media signal. When the digital switching controller 66 tells the graphics processor it is time to embed the graphics data, it either tells the graphics processor 76 how much data it is going to embed or it tells the graphics processor 76 when to stop. When the graphics processor 76 is instructed to embed the graphics data, it outputs the data to the digital video encoder 82 which converts the data to the appropriate video format. For example, if the graphics card 74 created the graphics data in RGB format, the digital video encoder 82 converts the data into digital video luminance/chrominance (Y/C) format. The digital video encoder 82 then outputs the data to the switch 72 which embeds the graphics data into the digital media signal.

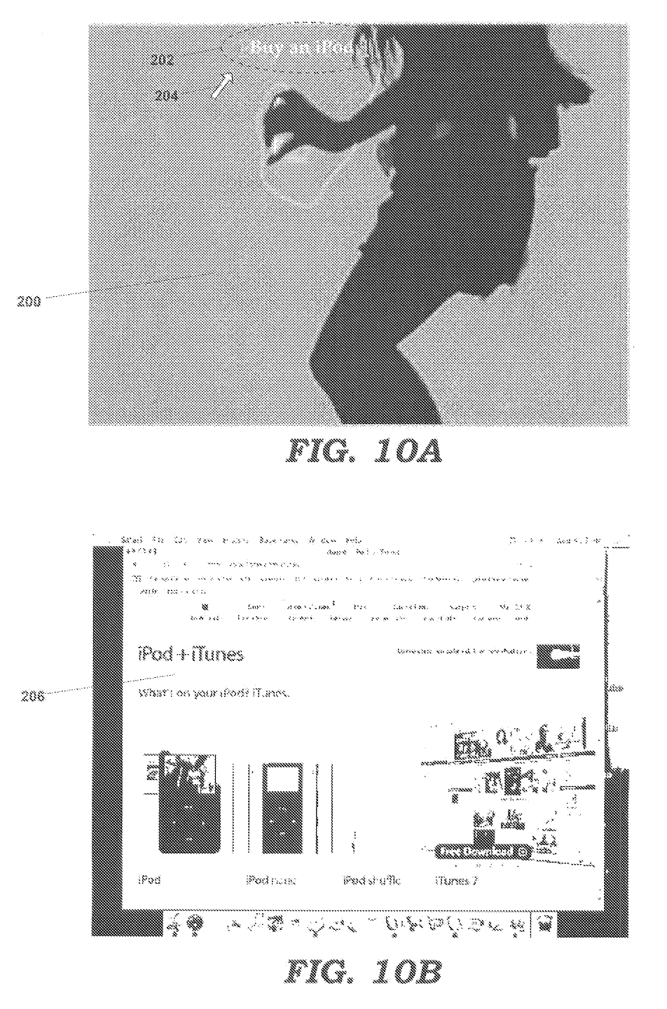

FIG. 10A depicts an example of television screen graphics generated by the embodiment of FIG. 6. While receiving a video data stream depicting a television advertisement 200 for an Apple IPod, the data extractor 34 detects and copies associated data in the video data stream that includes the textual phrase “Buy an iPod.” Based on this associated data, the graphics controller 38 generates a graphical representation of the same textual phrase and embeds it in the digital media signal as described previously. As a result, the graphical representation 202 of “Buy an iPod” appears on the television display 20 along with the primary video information for the television advertisement 200.

In this example, the associated data detected by the data extractor 34 also includes link information pointing to a webpage where a consumer may obtain further information and/or purchase an iPod. In this example, the associated data may be provided as a URL or an IP address. In a preferred embodiment, the associated data is automatically copied and sent to the interface controller 44 which provides the data to the computer 22a by way of the link 24a.

As shown in FIG. 6, the associated data may alternatively or additionally be transmitted wirelessly via a transmitter 45, such as a Bluetooth transmitter, to a wireless communication device 22b which is in communication range of the transmitter 45. The wireless communication device 22b, such as a cellular phone, PDA or laptop computer, may then be used to access the supplemental information to which the associated data points.

With reference again to FIG. 10A, when a user sees the text graphics 202 appear, this indicates to the user that supplemental information regarding the advertised product is available. To access that supplemental information, the user presses a button on a remote control device 46 (FIG. 6) to activate the interface controller 44 to send a request signal to the computer 22a. In response to the request signal, the computer 22a executes a browser application to access the webpage indicated by the URL. For example, the webpage may be stored on a server computer of a television advertiser computer system 22b. (FIG. 5A.) As shown in FIG. 10B, the webpage 206 is then displayed on the display device 62 (FIG. 9) of the computer 22a. In an alternative embodiment, the user may use a mouse, touch pad or remote control, to position a curser 204 to click on the text graphics 202 (FIG. 10A) which activates the interface controller 44 to send the request signal to the computer 22a.

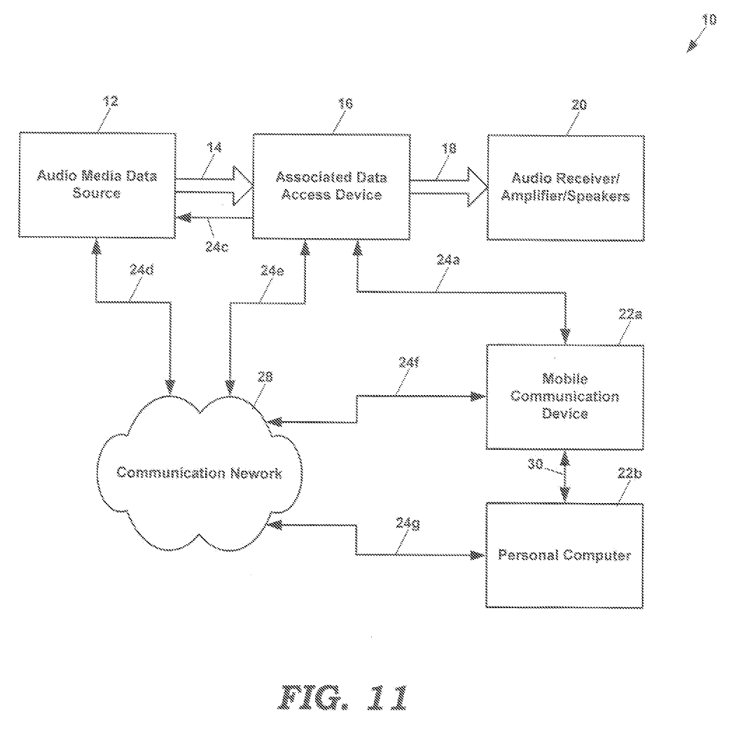

FIG. 11 depicts a preferred embodiment of the invention wherein the primary media content is audio programming, such as from a digital music file or a digital radio stream. In this embodiment, the media data source 12 is an audio media data source 12, such as a satellite radio service provider, a digital music file transferred via a network or a digital music file accessed from a CD or hard drive. The associated data access device 16 of this embodiment may be a component of a satellite radio receiver, a card in a personal computer, or a component of a CD player, MP3 player or other digital music player. The primary data presentation device 20 of this embodiment comprises an audio receiver/amplifier and associated audio reproduction devices, such as speakers or headphones. In the exemplary embodiment of FIG. 11, a first associated data receiving device 22a comprises a wireless mobile communication device, such as a cellular phone, PDA or laptop computer, which is in wireless communication with the associated data access device 16 via a wireless link 24, such as a WiFi, cellular, Bluetooth or infrared link. The embodiment of FIG. 11 may also include a second associated data receiving device 22b, such as a personal computer, which is in communication with the wireless mobile communication device 22a via the direct link 30 or via the communication network 28.

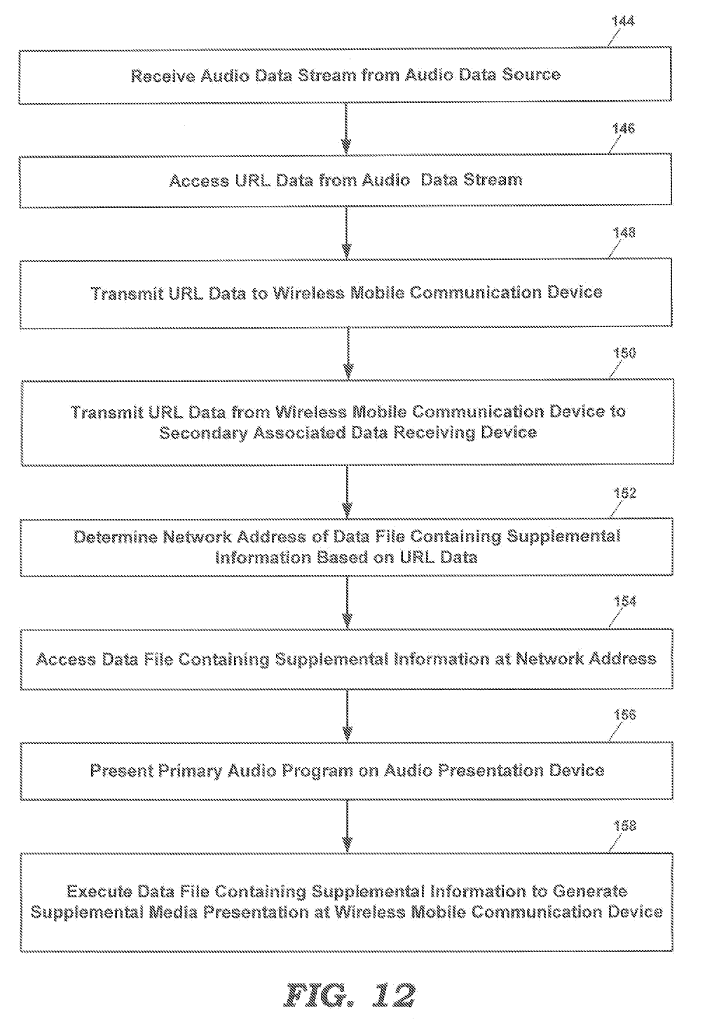

FIG. 12 depicts a method for transferring audio media information from an audio data source to a media recipient using the embodiment of the invention depicted in FIG. 11. In this embodiment, the method includes receiving audio data 14, such as an MPEG or MP3 audio stream, from the audio data source 12 (step 144). A URL embedded in the audio data 14 is accessed using the associated data access device 16 (step 146), and the URL is transmitted to the wireless mobile communication device 22a (step 148). Based on the URL, a network address of a supplemental information data file is determined (step 152). The supplemental information data file, such as a webpage, a video file or another audio file, is then accessed at the indicated address (step 154) and is provided to wireless mobile communication device 22a where the supplemental information is presented to the media recipient (step 158) or stored in memory for later access. At some point during the process, the primary audio content, such as the radio program, podcast, music or other audio program, is also presented to the media recipient via the audio receiver/amplifier and speakers 20 (step 156). Also at some point during the process, the URL data may be transferred from the wireless mobile communication device 22a to the personal computer 22b via the communication link 30 or the network 28 (step 150).

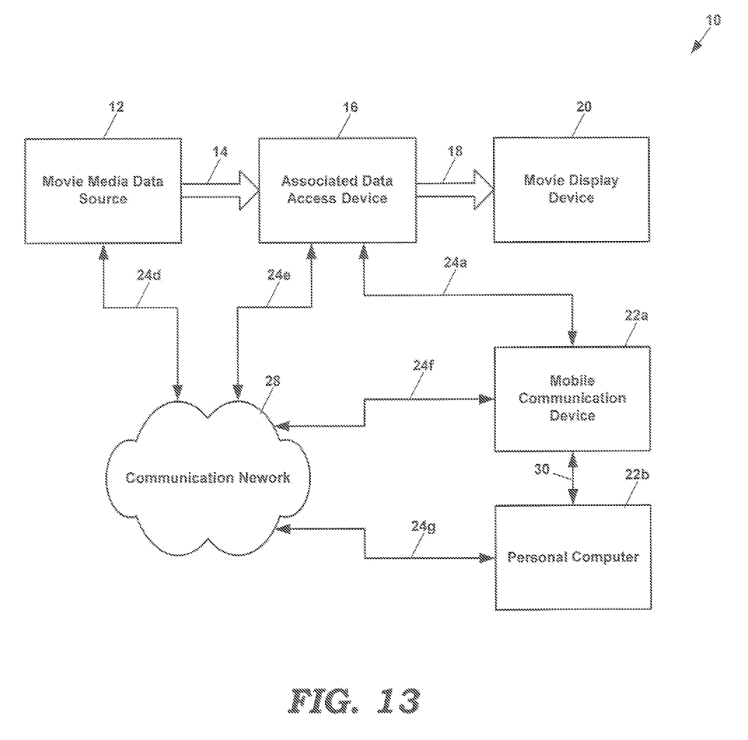

FIG. 13 depicts a preferred embodiment of the invention wherein the primary media content is an audio soundtrack from a cinematic motion picture presentation. In this embodiment, the media data source 12 is an audio media data source 12, such as a digital audio file accessed from a movie soundtrack or other magnetic or optical storage medium. The associated data access device 16 of this embodiment may be a component of a motion picture soundtrack processing device, such as a Dolby Digital processor or a Digital Theater System (DTS) processor. The primary data presentation device 20 of this embodiment comprises an audio receiver/amplifier and associated audio reproduction devices, such as speakers in a movie theater. In the exemplary embodiment of FIG. 13, a first associated data receiving device 22a comprises a wireless mobile communication device, such as a cellular phone, PDA or laptop computer, which is in wireless communication with the associated data access device 16 via a wireless link 24a, such as a WiFi, cellular, Bluetooth or infrared link. The embodiment of FIG. 13 may also include a second associated data receiving device 22b, such as a personal computer, which is in communication with the wireless mobile communication device 22a via the link 30 or the network 28.

The method depicted in FIG. 12 is also representative of a method for transferring primary movie soundtrack audio data and associated data using the embodiment of the invention depicted in FIG. 13. In this embodiment, the method includes receiving audio data 14, such as the Dolby Digital or DTS audio data, from the movie soundtrack 12 (step 144). A URL embedded in the audio data 14 is accessed using the associated data access device 16 (step 146), and the URL is transmitted to the wireless mobile communication device 22a (step 148). Based on the URL, a network address of a supplemental information data file is determined (step 152). The supplemental information data file, such as a webpage, a video file or another audio file, is then accessed at the indicated address (step 154) and is provided to wireless mobile communication device 22a where the supplemental information is presented to the media recipient (step 158) or stored in memory for later access. Contemporaneously with the associated data processing, the movie soundtrack is also presented to the media recipient via the audio receiver/amplifier and speakers 20 in the movie theater (step 156). Also at some point during the process, the URL data may be transmitted from the wireless mobile communication device 22a to the personal computer 22b via the communication link 30 or the network 28 (step 150). This part of the process may occur after the movie-goer has returned home and downloads the associated data from the wireless device 22a to the computer 22b.

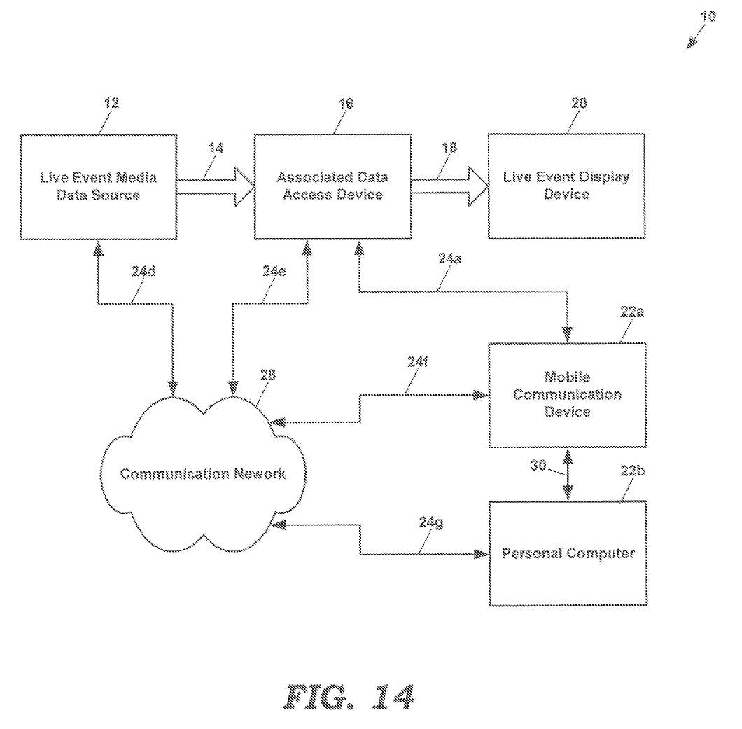

FIG. 14 depicts a preferred embodiment of the invention wherein the primary media content is video programming for a large-format video display. The display screen 20 of this embodiment may be a Sony JumboTron™ screen, such as is used in many sporting arenas, stadiums and public gathering places like Times Square in New York City. The display screen 20 of this embodiment also encompasses display screens used in other public places, such as shopping malls, retail stores, restaurants, sports bars and the like. The video data format for this embodiment may be any of the video formats described previously. Thus, the live event media data source 12 may comprise a computer hard drive, a DVD disk, a digital video tape or any other digital video source. Preferably, the associated data access device 16 of this embodiment functions in much the same way as the device 16 described above in reference to FIG. 6. In this embodiment, however, the preferred communication link 24 is wireless and the preferred associated data receiving device 22a is a mobile communication device, such as a Bluetooth-enabled cellular phone or PDA.

The embodiment of the invention depicted in FIG. 14 may be used during live events, such as sporting events or concerts. At such events, commercial or other informational presentations may be shown on a large-format video display 20 that is viewable within the event venue. While these presentations are being shown, associated data extracted from the primary video data stream 14 is transmitted via a wireless transmitter 45 in or near the event venue (see FIG. 6) to portable wireless devices 22a carried by spectators within the venue. For example, during a college football game, a video presentation promoting the home team may be shown on the display 20. During the presentation, associated data is transmitted within the venue which directs the spectators to supplemental information regarding the home team or the university. Another video presentation shown during the game may advertise a nearby restaurant, and the associated data may be directions to the restaurant and a special code for a discount on a food or beverage item.

The associated data may be a text message directed to each and every cellular phone in the venue, where the text message includes a special code the spectators may use to access information that is only available to those having the code. For example, the associated data may be a URL pointing to a webpage that is not otherwise accessible. In a preferred embodiment, the transmission from the transmitter 45 is a Bluetooth transmission which may be received only by Bluetooth-enabled phones, PDAs or other devices in the venue or the immediate vicinity. As with other embodiments described herein, the associated data may be transmitted from the wireless mobile communication device 22a to a personal computer 22b via a communication link 30 or the network 28. This transmission may occur after the event spectator has returned home and downloaded the associated data from the wireless device 22a to the computer 22b.

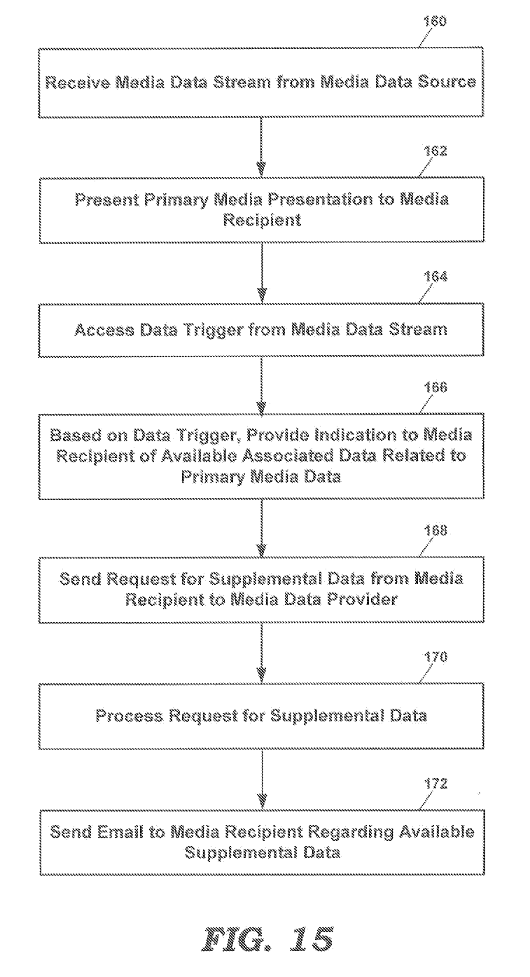

FIG. 15 depicts a method for providing access to associated data related to primary media data according to yet another embodiment of the invention. Although this method may be performed by several of the embodiments of the invention described herein, the following description is directed to the embodiment of FIG. 5B. An associated data access device, such as the television/computer interface 16, receives a television media data stream 14 from a television media data source (step 160). The television/computer interface 16 provides the primary television programming content 18 to a television display device 20 on which the programming is presented to a media recipient (step 162). The television/computer interface 16 extracts or copies a “trigger” data string from the television data stream (step 164). In a preferred embodiment, this trigger string is contained in the “user data” section of an MPEG stream as described above.

Based on the presence of the trigger string, the television/computer interface 16 generates a graphic icon, text, or window which is displayed on the television display device 20 and/or on a display device associated with the computer 22a (step 166). This icon or window provides an indication to the media recipient that supplemental information is available. When the media recipient clicks on the icon using the control device 46 (FIG. 6) or a mouse connected to the computer 22a, a request string is generated and transmitted from the television/computer interface 16 via the link 24e, the communication network 28 and the link 24g to a third-party computer system 22b, such as a computer system associated with an advertiser (step 168). The request string of step 168 could also be transmitted to the third-party computer system 22b by way of the links 24c and 24d, the communication network 28 and the link 24g. The request string initiates a request for supplemental data related to the television programming that included the trigger string. This request is processed by the computer system 22b and a response is sent from the computer system 22b to the media recipient (step 170). In a preferred embodiment, the response is in the form of an email message directed via the communication network 28 to an email server 22c associated with the media recipient's email address (step 172). The media recipient may then use the computer 22a to access the email message residing on the email server 22c via the network 28. In this embodiment, the email message includes supplemental information and/or associated data, such as a URL directing the media recipient to further supplemental information available at a website.

As shown in FIG. 5B, one embodiment of the invention includes a television network computer system 27 that may communicate with the personal computer 22a via the communication network 28. The personal computer 22a of this embodiment may download from the television network computer system 27 a special application for accessing associated data. When installed and running on the personal computer 22a, the special application uses trigger strings accessed from the television media stream 14 to provide links to supplemental information residing on the television network computer system 27. In this case, the supplemental information may include, for example, scheduling information related to the network's television shows. This embodiment illustrates a situation wherein the associated data and the supplemental data originate from a common source, i.e. the television network, but they are directed through two different communication channels; the primary media data through the television data source 12, such as a satellite or cable television provider, and the associated data from the television network computer system 27 via the communication network 28.

The embodiment of FIG. 5B, in essence, creates a bridge across the television and Internet platforms. It allows television viewers to jump from television directly to a specific site on the Internet. Using this embodiment, advertisers can create links to information on the web through TV commercials, infomercials and product placements. Also, this embodiment enables television networks to create a cross-platform experience by enhancing television shows and content with linked media and information on the Internet. Television networks can also use these links to receive input from viewers regarding what the viewers would like to see next or to receive votes in an interactive poll. For example, the embodiment of FIG. 5B could be used to allow the television audience to vote on what they would like to see happen next on a television program. For instance, the television program could have been filmed in numerous ways and the audience can vote for whether they want the show to go in direction A or direction B. Depending on the outcome of the vote, the television network can show clip A or B. This embodiment could also be used by viewers to request a reminder by email or text message to watch or record a program.

The email server 22c of this embodiment also allows for the invention to accumulate massive amounts of request data. For example, the server 22c could save and compile all link request activity on all television channels. This data could then be used to create detailed reports of many factors, such as how many viewers are or were watching, what they were watching, and how interested they were in the programming.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for transferring media information from a media data source to a media recipient, the method comprising:
(a) receiving a media data stream from the media data source, the media data stream including primary data and associated data, where the primary data comprises a primary media presentation and the associated data points to supplemental information that is related to the primary media presentation;
(b) presenting the primary media presentation to the media recipient based on the primary data;
(c) accessing the associated data in the media data stream;
(d) determining based on the associated data a location of the supplemental information;
(e) accessing the supplemental information at the location determined in step (d); and
(f) presenting the supplemental information to the media recipient.

2. The method of claim 1 further comprising, after step (c), providing the associated data to a first associated data receiving device.

3. The method of claim 2 further comprising transferring the associated data from the first associated data receiving device to a second associated data receiving device.

4. The method of claim 3 wherein
the step of providing the associated data to the first associated data receiving apparatus comprises providing the associated data via a network connection to a first computing device selected from the group consisting of a server computer, a personal computer, a laptop computer, a personal digital assistant and a wireless communication device, and
the step of transferring the associated data from the first associated data receiving apparatus to the second associated data receiving apparatus comprises transferring the associated data from the first computing device to a second computing device selected from the group consisting of a server computer, a personal computer, a laptop computer, a personal digital assistant and a wireless communication device, and
steps (d), (e) and (f) are performed using the first computing device or the second computing device.

5. The method of claim 2 wherein the step of providing the associated data to the first associated data receiving apparatus comprises transmitting the associated data to a wireless mobile communication device, and steps (d), (e) and (f) are performed using the wireless mobile communication device.

6. The method of claim 1 wherein
step (a) comprises receiving the media data stream from a television programming service provider, and
step (b) comprises presenting television programming on a television display device.

7. The method of claim 1 wherein
step (a) comprises receiving the media data stream from a radio programming service provider, and
step (b) comprises presenting radio programming using an audio device.

8. The method of claim 1 wherein step (a) comprises receiving the media data stream from a digital media player device selected from the group consisting of a digital versatile disk (DVD) player, a compact disk (CD) player and a digital music player.

9. The method of claim 1 wherein
step (a) comprises receiving the media data stream from a cinematic movie presentation device, and
step (b) comprises presenting a cinematic feature in a movie theater using a projection device.

10. The method of claim 1 wherein
step (a) comprises receiving the media data stream from a video data source for a large-format video display device used at a live event, and
step (b) comprises presenting video programming on the large-format video display device at the live event.

11. The method of claim 1 wherein step (c) comprises detecting the associated data in the media data stream, decoding the associated data and copying decoded associated data to a memory device.

12. The method of claim 1 wherein
step (c) comprises accessing one or more Uniform Resource Locator (URL) data strings encoded in the media data stream,
step (d) comprises determining a network address of the supplemental information based at least in part on the one or more Uniform Resource Locator (URL) data strings,
step (e) comprises accessing a data file containing the supplemental information at the network address determined in step (d), and
step (f) comprises executing the data file containing the supplemental information to generate a supplemental media presentation for the media recipient.

13. The method of claim 1 wherein step (c) comprises accessing one or more data tags that indicate the availability of the supplemental data information stored on a remote computer storage device.

14. An apparatus for operating on a media data stream that contains primary data and associated data, where the primary data comprises a primary media presentation and the associated data points to supplemental information that is related to the primary media presentation, the apparatus comprising:
an associated data access device comprising:
a media data stream input for receiving the media data stream from a media data source;
an extraction circuit for accessing the associated data in the media data stream;
a first associated data output for providing the associated data to an associated data receiving apparatus; and
a primary data output for providing the primary data to a primary data presentation device; and
a first associated data receiving apparatus for receiving the associated data, for accessing the supplemental information at a location indicated by the associated data, and for presenting the supplemental information.

15. The apparatus of claim 14 wherein the first associated data receiving apparatus comprises a second associated data output for providing the associated data to a second associated data receiving apparatus, the second associated data output selected from the group consisting of a wireless data interface device and a wired data interface device.

16. The apparatus of claim 14 wherein
the first associated data output includes a wireless data transmitter for transmitting the associated data to an associated data receiving apparatus; and
the first associated data receiving apparatus comprises a wireless mobile communication device.

17. The apparatus of claim 16 wherein the wireless mobile communication device comprises a device selected from the group consisting of a cellular phone, a personal digital assistant device having wireless communication capability and a laptop computer having wireless communication capability.

18. The apparatus of claim 14 wherein the first associated data output comprises a network interface for transferring the associated data to a communication network, and the first associated data receiving apparatus comprises a computing device connected to the communication network, the computing device selected from the group consisting of a personal computer, a server computer, a laptop computer and a personal digital assistant.

19. The apparatus of claim 14 wherein the associated data access device and first associated data receiving apparatus are disposed within a single housing.

20. The apparatus of claim 19 wherein the associated data access device and the first associated data receiving apparatus are components of a device selected from the group consisting of a cellular phone, a digital media player, a digital music player, a digital versatile disk (DVD) player, a compact disk (CD) player, a personal digital assistant device, a laptop computer, a personal computer, a satellite television receiver unit, a cable television receiver unit, a terrestrial television receiver unit, a satellite radio receiver unit and a terrestrial radio receiver unit.

21. The apparatus of claim 14 wherein the associated data access device is a component of a device selected from the group consisting of a cellular phone, a digital media player, a digital music player, a digital versatile disk (DVD) player, a compact disk (CD) player, a personal digital assistant device, a laptop computer, a personal computer, a satellite television receiver unit, a cable television receiver unit, a terrestrial television receiver unit, a satellite radio receiver unit and a terrestrial radio receiver unit.

22. The apparatus of claim 14 wherein
the media data stream input comprises a television data stream input for receiving a television data stream from a television programming service provider,
the extraction circuit is for accessing the associated data in the television data stream, and the primary data output is for providing primary television programming data to a television display device.

23. The apparatus of claim 14 wherein the first associated data receiving apparatus is a component of a personal computer and the supplemental information is provided to a display device associated with the personal computer.

24. The apparatus of claim 14 wherein
the media data stream input comprises a radio data stream input for receiving a radio data stream from a radio programming service provider,
the extraction circuit is for accessing the associated data in the radio data stream, and the primary data output is for providing primary radio programming to an audio device.

25. The apparatus of claim 14 wherein
the media data stream input comprises a digital video input for receiving digital video data from a digital versatile disk (DVD) reader device,
the extraction circuit is for accessing the associated data in the digital video data, and the primary data output is for providing digital video programming from the digital video data to a video display device.

26. The apparatus of claim 14 wherein
the media data stream input comprises a cinematic movie data input for receiving cinematic movie data from a cinematic movie presentation device,
the extraction circuit is for accessing the associated data in the cinematic movie data, and the primary data output is for providing cinematic movie programming to a cinematic movie programming presentation device.

27. The apparatus of claim 26 wherein the cinematic movie data comprises audio data.

28. The apparatus of claim 14 wherein
the media data stream input comprises a large-format video data input for receiving video data from a video data source for a large-format video data display device,
the extraction circuit is for accessing the associated data in the video data, and the primary data output is for providing video programming to the large-format video display device.

29. The apparatus of claim 14 wherein
the extraction circuit is for accessing one or more Uniform Resource Locator (URL) data strings encoded in the media data stream, and
the first associated data receiving apparatus is for receiving the one or more Uniform Resource Locator (URL) data strings, determining a network address of the supplemental information based at least in part on the one or more Uniform Resource Locator (URL) data strings, and accessing a data file containing the supplemental information at the network address.

30. The apparatus of claim 29 wherein the first associated data receiving apparatus is further for executing the data file containing the supplemental information to generate a supplemental media presentation.

31. A method for transferring media information from a television media data source to a television media recipient, the method comprising:
(a) receiving a television media data stream from the television media data source, the television media data stream including primary data and associated data, where the primary data comprises a primary television media presentation and the associated data points to supplemental information that is related to the primary television media presentation;
(b) presenting the primary television media presentation to the media recipient on a television display device;
(c) accessing the associated data in the television media data stream;
(d) providing an indication in the primary television media presentation that supplemental information is available, where the indication is based on the associated data;
(e) sending a request regarding the supplemental information, the request sent via a communication network from a computing device associated with the television media recipient;
(f) determining based on the request a network address of the supplemental information;
(g) sending a message via a communication network to inform the television media recipient regarding availability of the supplemental information at the network address;
(h) accessing the message via a communication network using a computing device associated with the media recipient; and
(i) accessing the supplemental information via a communication network using a computing device associated with the media recipient.

32. The method of claim 31 wherein step (d) comprises displaying an icon on the television display device.

33. The method of claim 31 wherein:
step (f) comprises determining the network address of the supplemental information based at least in part on Uniform Resource Locator (URL) data embedded in the television media data stream;
step (g) comprises sending the message containing the URL data; and
step (i) comprises accessing the supplemental information at the network address indicated by the URL data.

34. The method of claim 31 wherein step (g) comprises sending an email message to an email server that is accessible to the computing device associated with the media recipient.

35. The method of claim 31 wherein step (i) comprises accessing the supplemental information using a network browser application on the computing device associated with the media recipient.
